(19) United States
(12) Patent Application Publication
(10) Pub. No.: US 2015/0313328 A1
(43) Pub. Date: Nov. 5, 2015

(54) Electronic Clasp

(71) Applicant: Jill MacKay, Bellvue, CO (US)

(72) Inventor: Jill MacKay, Bellvue, CO (US)

(21) Appl. No.: 14/266,564

(22) Filed: Apr. 30, 2014

(51) Int. Cl. A44C 15/00; F21V 23/06; A44C 5/20; F21L 4/00

(52) U.S. Cl. CPC A44C 15/0015; F21L 4/00; F21V 23/06; A44C 5/2071

(57) ABSTRACT

A system and method for illuminating jewelry. The system includes a top shell releasably coupled to a bottom shell. A coupler couples the top shell and the bottom shell. The system also includes a bulb which is coupled to the top shell via a top lead. The bulb is coupled to the bottom shell via a bottom lead. When the shells are coupled, an electrical circuit is closed causing the bulb to be illuminated by a battery stored within one of the shells.

### BACKGROUND OF THE INVENTION

1. Technical Field

The present invention relates to a system and method for illuminating jewelry and other items.

2. Description of Related Art

Jewelry such as necklaces or bracelets are used to decorate or accessories. However, often the jewelry alone is insufficient for accessorizing. Consequently, there is a need to enhance the jewelry.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart of a circuit in one embodiment;

FIG. 2a is a top perspective view of a top shell in one embodiment;

FIG. 2b is a top perspective view of a bottom shell in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

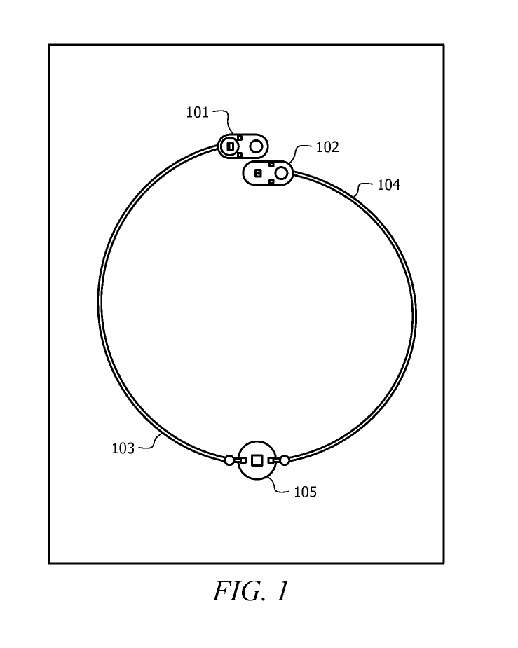

FIG. 1 is a perspective view of a circuit in one embodiment. As used herein, a circuit refers to a circuit which, when closed, allows for the flow of electricity. The circuit shown, when closed, allows electrical current to flow to a bulb 105 through leads 103, 104. A bulb, as used herein, refers to any light emitting device and includes light bulbs, LED lights, organic LED lights, etc.

The bulb 105 is coupled to a first lead 103 and a second lead 104. The leads 103, 104 can comprise any conductive material. The leads 103, 104 can include wire, metal, conductive thread, conductive ink, yarn, beading wire, etc. Virtually any material which is conductive can be utilized. In one embodiment the conductive material is encased in an insulating material such as a plastic or polymer to prevent the leads from shorting. The first lead 103 is coupled to a top shell 101, and the second lead 104 is coupled to a bottom shell 102. The top 101 and bottom shells 102 couple to form a clasp. A clasp, as used herein, refers to an item which can be releasably coupled to form a closed loop. In one embodiment the clasp is used as a jewelry closure and the power supply for a light emitting device. Clasps are used in necklaces, bracelets, etc. A clasp, when closed, allows the necklace, for example, to be worn securely around the user's neck. When open, the clasp allows the necklace to be removed. Further, in one embodiment, discussed in more detail below, when the clasp is closed and coupled with a battery, it creates a closed electrical circuit which operates a light. When the clasp is closed, the circuit is broken and the light is stopped.

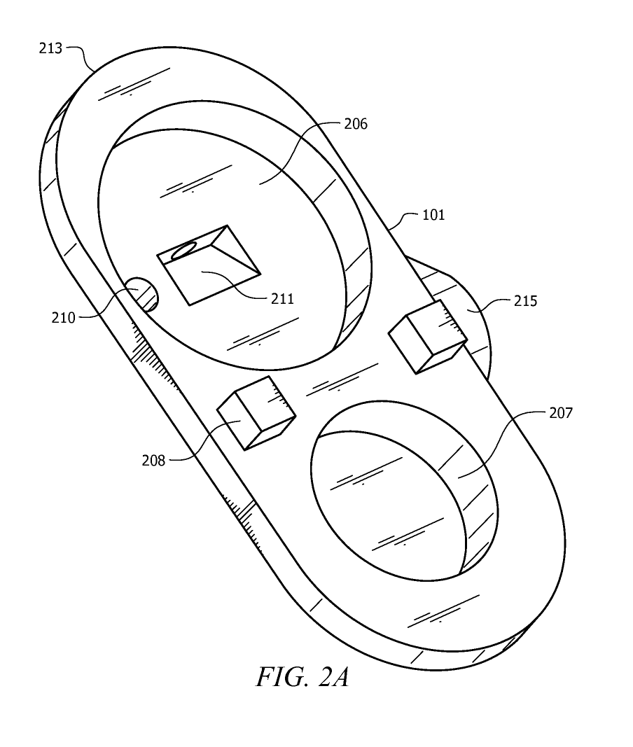

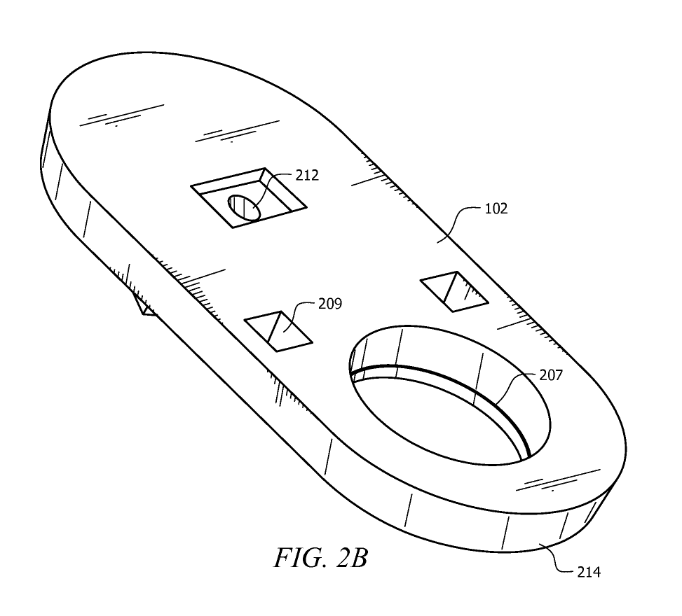

FIG. 2a is a top perspective view of a top shell in one embodiment. FIG. 2b is a top perspective view of a bottom shell in one embodiment. The top 101 and bottom 102 shells can comprise virtually any material, including but not limited to, plastic, polymer, rubber, clay, or other moldable material. In one embodiment the shells 101, 102 comprise an insulating material. In one embodiment the shells 101, 102 comprise an inner non-conductive material such that the circuit will not short. However, the external surface of the shells 101, 102 can comprise any material for decorative purposes. In one embodiment the shells 101, 102 comprise a plastic or polymer. The shells 101, 102 can be constructed via any method known in the art including extrusion, molding, blow molding, die casting, 3-D printing, etc.

As noted, the top 101 and bottom shells 102 together form a clasp. As such, the top 101 and bottom shells 102 are releasably coupled. In one embodiment the top shell 101 and the bottom shell 102 are coupled via a coupler. A coupler, as used herein, refers to a device which couples two objects. Virtually any type of coupler which provides for releasable coupling can be utilized. These include, but are not limited to, mechanical snaps, clasps, trailer hitch clasp, box clasp, and magnets. In one embodiment, and as depicted, the clasp comprises magnets. As depicted, the top shell 101 comprises a magnet recess 207. In one embodiment, a magnet is inserted and adhered, via any known adhering method, to the top shell 101. Likewise, in one embodiment, a magnet is inserted and adhered to the bottom shell 102. In one embodiment the magnet in the top shell 101 comprises a dissimilar polarity to the magnet in the bottom shell 102 such that the two magnets attract. Thus, to couple the top shell 101 to the bottom shell 102, the two magnets are closely placed to allow for the magnetic coupling. To unclasp the shells, a force greater than the magnetic force between the two magnets is applied to uncouple the top shell 101 from the bottom shell 102. The size and strength of the magnets can be adjusted to compensate for the weight of the jewelry.

In one embodiment, the top shell 101 comprises at least one knob 208. In certain embodiments, the bottom shell 102 comprises at least one knob recess 209 to receive the knob 208. The knob 208 comprises any protrusion which helps to align and further couple the two shells. As depicted the top shell 101 comprises two knobs 208 which align to fit within the two knob recesses 209 located on the bottom shell 102. While the knobs 208 are depicted as being located on the top shell 101, in other embodiments the knobs 208 are located on the bottom shell 102 with the top shell 101 having the knob recess 209.

In one embodiment, and as depicted, the top shell 101 comprises a separator bump 215. The separator bump 215 assists the user in decoupling the two shells. A user presses a force upon the separator bump 215 to separate the top shell 101 from the bottom shell 102. In other embodiments the separator bump 215 is located on the bottom shell 102 whereas in other embodiments the top 101 and bottom shell 102 each comprise a separator bump 215.

As noted, in one embodiment, the clasp comprises a battery. As depicted in FIG. 2a, the top shell 101 comprises a battery recess 206 for receiving a battery. While an embodiment will be described wherein the top shell 101 comprises a battery recess 206, this is for illustrative purposes only and should not be deemed limiting. In other embodiments the bottom shell 102 comprises a battery recess. In still other embodiments, both the top 101 and bottom 102 shell comprise a battery recess. When coupled, the top shell 101 and the bottom shell 102 sandwich and enclose the battery.

Virtually any type of battery can be utilized. In one embodiment the battery comprises a watch battery. In one embodiment the battery comprises a lithium coin battery of varying sizes.

The battery can be coupled to the battery recess via any method or device known in the art. Thus, the battery can be coupled mechanically or chemically with adhesives or the like. In one embodiment the battery is removeably coupled so that the battery is replaceable. As such, when the battery has died, the battery can be removed and replaced with a new battery.

In one embodiment, the clasp comprises a battery access point 210. The battery access point 210, in one embodiment, comprises a hole which connects the outer shell to the inner shell. A small object can be placed through the hole to push the battery from the shell. This aids in removal of the battery for replacement, as an example.

The battery, in one embodiment, comprises two leads: a positive and a negative. When a closed circuit connects the positive lead and the negative lead, electric current flows. Each shell comprises a lead recess which allows the first and second leads to connect to the battery.

As depicted, the top shell 101 comprises a top lead recess 211. This is a recess located on the inner side of the shell. The inner side of the shell is the side which is inaccessible when the two shells are coupled. The outer side of the shell is the side which is accessible when the two shells are coupled. The top lead recess 211 allows the top lead 103 to electrically couple with the battery. The top lead 103 is inserted through the top lead entry point 213. In one embodiment the top lead entry point 213 is located on the outer layer of the top shell 101. The top lead entry point 213 is coupled to the top lead recess 211. In one embodiment there is a channel, encased by the material of the top shell 101, which travels between the top lead entry point 213 and the top lead recess 211. The top lead 103 is inserted through the tunnel. The tunnel can be created in the mold, it can be channeled by removing material, or it can be removed by any method known in the art.

Referring to FIG. 2b, the bottom shell 102 comprises a bottom lead recess 212. As depicted, this recess is located on the inner side of the shell. The bottom lead recess 212 allows the bottom lead 104 to electrically couple with the battery. The bottom lead 104 is inserted through the bottom lead entry point 214. In one embodiment the bottom lead entry point 214 is located on the outer layer of the top shell 101. The bottom lead entry point 214 is coupled to the bottom lead recess 212. Like the top shell 101, in one embodiment, the bottom shell 102 comprises a tunnel, encased by material of the bottom shell 102, which travels between the bottom lead entry point 214 and the bottom lead recess 212 through which the bottom lead 104 can be inserted. The tunnel can be created with any method previously discussed including 3D printing, injection molding, cast, etc. In the embodiment depicted in FIG. 2b, the tunnel is located atop the magnet recess 207. In other embodiments the tunnel is located to the side of the magnet recess 207.

The tunnel helps secure and protect the leads. In one embodiment wherein the top 101 and bottom shells 102 comprise insulting material, the tunnel provides increased safety as it reduces the risk of shock to the user.

The lead recesses 212, 211 provide sufficient room to electrically couple the leads to the battery. In one embodiment the leads are not directly coupled by instead are positioned sufficiently close the battery so as to be electrically coupled.

The location of the lead entry points 213, 214 illustrated in FIG. 2 is for illustrative purposes only and should not be deemed limiting. The lead entry points 213, 214 can be placed at an end of the shells as depicted, or they can be located on the side or face of the shells.

When the two shells of FIG. 2 are coupled, their respective lead entry points 213, 214 are on opposing sides. As an example, if the top shell 101 is flipped over a vertical axis so as to align with the bottom shell, the top lead entry point 213 would be located on the top left of the clasp whereas the bottom lead entry point 214 would be located at the bottom right of the clasp. Such an arrangement allows the clasp to be coupled together without overlap of either of the leads. Such arrangement is illustrated in FIG. 1.

Now that the components of the clasp in one embodiment have been described, the operation and use will now be described. First a top shell 101 is obtained. The magnet can be pre-installed or it can be installed by the user. Next, a first end of the top lead 103 is inserted through the top lead entry point 213. The top lead 103 is pushed through so it exits into the top lead recess 211. Here a crimp bead is inserted onto the first end of the top lead 103, and then the crimp bead is crimped. A crimp bead increases the electrical contact with the battery. After the top lead 103 has been installed, the battery is inserted into the top shell 101.

The second end of the top lead 103 is then attached to an item comprising a bulb 105. The item can comprise a plate, trinket, or any item traditionally used as jewelry. In one embodiment the bulb 105 is covered a bead, set behind or adjacent a stone, crystal, of the like. Further, in other embodiments the bulb 105 is embedded in resin with or without decorate elements. Further, the bulb 105 can be encased in resin, polymer clay, glass, or cage beads of any material. As can be seen, virtually any type of jewelry can be modified to include a bulb 105.

Next, a bottom shell 102 is obtained. The first end of the bottom lead 104 is inserted through the bottom lead entry point 214 and pushed so that it exits into the bottom lead recess 212. The same crimping process is applied. The second end of the bottom lead 104 is then coupled to the item.

Thereafter, the top shell 101 and the bottom shell 102 are coupled. Both leads are now electrically coupled with the battery such that if the circuit is closed, current will flow to the bulb 105. In one embodiment the item comprising the bulb 105 comprises an on-off switch to control operation of the bulb 105. If the switch is on, and the circuit is closed, the bulb 105 will light. The powering of the bulb 105 can be stopped if either the switch is turned off or the two shells are decoupled.

While one embodiment utilizing crimping has been discussed, this is for illustrative purposes only and should not be deemed limiting. Any method or device which electrically couples the leads to the battery can be utilized.

The clasp described herein has several benefits. First, it provides an easy way for the user to put on and remove the jewelry. Users are familiar with traditional jewelry clasps, and the clasp described herein, in one embodiment, operates similar to a traditional clasp in that it is releasably coupled to allow jewelry and the like to be removed.

Second, the clasp provides increased battery life. As noted, the circuit is broken and the current is stopped if the two shells are not coupled. When a user removes the clasp, decoupling the shells, the current is stopped and the battery is not active until the clasp is recoupled. Thus, when the jewelry is removed, the current is automatically ceased. This is an advantage over prior art electrical charms where the battery is located on the charm. In such situations, it is common for the user to forget to turn the charm to the off position. Thus, the next time the user desires to wear the charm, the battery is drained. The clasp described herein avoids this problem by automatically ceasing the current when the jewelry is not being worn.

Third, the clasp is aesthetically pleasing. The clasp resembles prior art clasps but it includes a battery. In one embodiment the clasp is about an inch in length, half an inch wide, and about half an inch thick. Such a clasp is not overly noticeable and will not take attention away from the necklace or charm.

Fourth, the clasp is versatile. Many different jewelry pieces can utilize a single clasp. The leads of one jewelry piece can be decoupled from the clasp and replaced with leads for a different jewelry piece.

Fifth, the clasp is an effective teaching tool to teach the user about simple circuits. Thus, the clasp is a tool which can be used for science, technology, engineering, and math (“STEM”) educational purposes.

While the clasp has been described in reference to jewelry, this is for illustrative purposes and should not be deemed limiting. There are many other applications for which it is desirable to light a charm or bulb. For example, the clasp can be used to illuminate hats, sweaters and other clothing, Quilts and other blankets, eyeglasses, hats, costumes, etc. Virtually any item which can utilize a clasp and which illumination is desired can use the clasp described herein.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.

Clause 1. A system for illuminating jewelry, said system comprising:
a top shell releasably coupled to a bottom shell;
a coupler which couples the top shell and the bottom shell;
a bulb;
wherein a top lead couples the bulb to the top shell, and wherein a bottom lead couples the bulb to the bottom shell.

Clause 2. The system of any preceding or proceeding clause wherein said coupler comprises a magnet.

Clause 3. The system of any preceding or proceeding clause wherein the top shell comprises a first magnet and wherein the bottom shell comprises a second magnet.

Clause 4. The system of any preceding or proceeding clause wherein the top shell comprises at least one knob, and wherein the bottom shell comprises at least one knob recess for receiving said at least one knob.

Clause 5. The system of any preceding or proceeding clause further comprising a battery enclosed within said top and bottom shells.

Clause 6. The system of any preceding or proceeding clause wherein the top shell comprises a battery recess for storing the battery.

Clause 7. The system of any preceding or proceeding clause further comprising a battery access point.

Clause 8. The system of any preceding or proceeding clause wherein said top shell comprises a top lead entry point and a top lead recess point, wherein the top lead recess point is adjacent to a battery recess.

Clause 9. The system of any preceding or proceeding clause further comprising a tunnel connecting the top lead entry point and the top lead recess point, where the top lead is located in the tunnel.

Clause 10. The system of any preceding or proceeding clause wherein said bottom shell comprises a bottom lead entry point and a bottom lead recess point.

Clause 11. The system of any preceding or proceeding clause wherein the bottom lead entry point is located on an opposite side from said top lead entry point when the top and bottom shells are coupled.

Clause 12. A conductive clasp comprising:
a top shell comprising a battery recess, a magnet recess, and a top lead recess;
a bottom shell comprising a magnet recess and a bottom lead recess;
wherein the top and bottom shells are releasably coupled.

Clause 13. The conductive clasp of any preceding or proceeding clause wherein the top shell comprises at least one knob and wherein the bottom shell comprises at least one knob recess for receiving the at least one knob.

Clause 14. The conductive clasp of any preceding or proceeding clause wherein the top shell comprises a first magnet and wherein the bottom shell comprises a second magnet.

Clause 15. The conductive clasp of any preceding or proceeding clause wherein said first and second magnets are enclosed when said top and bottom shells are coupled.

What is claimed is:

1. A system for illuminating jewelry, said system comprising:
a top shell releasably coupled to a bottom shell;
a coupler which couples the top shell and the bottom shell;
a bulb;
wherein a top lead couples the bulb to the top shell, and wherein a bottom lead couples the bulb to the bottom shell.

2. The system of claim 1 wherein said coupler comprises a magnet.

3. The system of claim 2 wherein the top shell comprises a first magnet and wherein the bottom shell comprises a second magnet.

4. The system of claim 1 wherein the top shell comprises at least one knob, and wherein the bottom shell comprises at least one knob recess for receiving said at least one knob.

5. The system of claim 1 further comprising a battery enclosed within said top and bottom shells.

6. The system of claim 5 wherein the top shell comprises a battery recess for storing the battery.

7. The system of claim 6 further comprising a battery access point.

8. The system of claim 1 wherein said top shell comprises a top lead entry point and a top lead recess point, wherein the top lead recess point is adjacent to a battery recess.

9. The system of claim 8 further comprising a tunnel connecting the top lead entry point and the top lead recess point, where the top lead is located in the tunnel.

10. The system of claim 8 wherein said bottom shell comprises a bottom lead entry point and a bottom lead recess point.

11. The system of claim 10 wherein the bottom lead entry point is located on an opposite side from said top lead entry point when the top and bottom shells are coupled.

12. A conductive clasp comprising:
a top shell comprising a battery recess, a magnet recess, and a top lead recess;
a bottom shell comprising a magnet recess and a bottom lead recess;
wherein the top and bottom shells are releasably coupled.

13. The conductive clasp of claim 12 wherein the top shell comprises at least one knob and wherein the bottom shell comprises at least one knob recess for receiving the at least one knob.

14. The conductive clasp of claim 12 wherein the top shell comprises a first magnet and wherein the bottom shell comprises a second magnet.

15. The conductive clasp of claim 10 wherein said first and second magnets are enclosed when said top and bottom shells are coupled.
